(19) United States
(12) Patent Application Publication
(10) Pub. No.: US 2005/0079032 A1
(43) Pub. Date: Apr. 14, 2005

(54) Link assembly for a vehicle suspension system

(76) Inventors: Jiri Pazdirek, Schaumburg, IL (US); Gareth Wallace, Palos Heights, IL (US)

Correspondence Address: Dana Andrew Alden;MacLean-Fogg Company, 1000 Allanson Road, Mundelein, IL, 60060, US

(21) Appl. No.: 10/939,801

(22) Filed: Sep. 13, 2004

Related U.S. Application Data
(63) Continuation-in-part of application No. 10/378,641, filed on Mar. 4, 2003.
Application No. 10/378,641 is a continuation of application No. 09/860,880, filed on May 18, 2001, now Pat. No. 6,572,127.

(51) Int. Cl. F16B 1/00

(52) U.S. Cl. 411/389; 280/93.502

(57) ABSTRACT

A link assembly comprising a shaft provided with a positioning surface that includes threads, an arm coupler including an interfacing assembly and a pair of grommet contacting members, wherein the interfacing assembly includes an interfacing member that receives the positioning surface and inner and outer grommets that are provided with inner surfaces that receive the interfacing member, and the pair of grommet contacting members includes an inner grommet contacting member that receives the positioning surface shaft and contacts the inner grommet and an outer grommet contacting member that receives the positioning surface and contacts the outer grommet.

This application is a continuation-in-part of application Ser. No. 10/378,641, filed Mar. 4, 2003, the disclosure of which is hereby incorporated herein by reference, which is a continuation of application Ser. No. 09/860,880, filed May 18, 2001, now U.S. Pat. No. 6,572,127, the disclosure of which is hereby incorporated herein by reference.

### FIELD OF THE INVENTION

This invention relates generally to vehicle suspension systems. It relates particularly to a link assembly for a suspension system.

### BACKGROUND OF THE INVENTION

Motor vehicles have long been provided with independent suspension systems to absorb road shocks and other vibrations and provide a smoother, more comfortable ride. In suspension systems of this type, a stabilizer bar is normally incorporated to increase roll resistance and improve the steering to stability of the vehicle. Typically, the stabilizer bar is a torsion rod which extends transversely of the vehicle. It has an integral crank arm provided at each end. The rod is rotatably supported from the vehicle chassis adjacent each crank arm and each crank arm is coupled to a suspension arm by a connector link assembly. The present invention is an improved link assembly.

### SUMMARY OF THE INVENTION

The scope of the present invention is defined solely by the appended claims, and is not affected to any degree by the statements within this summary. Briefly stated, a link assembly embodying features of the present invention comprises a shaft provided with a positioning surface that includes threads, an arm coupler including an interfacing assembly and a pair of grommet contacting members, wherein the interfacing assembly includes an interfacing member that receives the positioning surface and inner and outer grommets that are provided with inner surfaces that receive the interfacing member, and the pair of grommet contacting members includes an inner grommet contacting member that receives the positioning surface shaft and contacts the inner grommet and an outer grommet contacting member that receives the positioning surface and contacts the outer grommet.

### BRIEF DESCRIPTION OF THE DRAWINGS

FIG. 1 depicts a sectional view of a link assembly of the presently preferred embodiment.

FIG. 2 depicts a sectional view of an interfacing member of a link assembly of the presently preferred embodiment.

FIG. 3 depicts a sectional view of a link assembly of the presently preferred embodiment.

FIG. 4 depicts a sectional view of a grommet of a link assembly of the presently preferred embodiment.

FIG. 5 depicts a sectional view of a link assembly of the presently preferred embodiment.

FIG. 6 depicts a sectional view of a positioning member of a link assembly of the presently preferred embodiment.

FIG. 7 depicts a sectional view of a grommet contacting member of a link assembly of the presently preferred embodiment.

FIG. 8 depicts an end view of a grommet contacting member of a link assembly of the presently preferred embodiment.

FIG. 9 depicts a perspective view of a grommet contacting member of a link assembly of the presently preferred embodiment.

FIG. 10 depicts a sectional view of a shaft of a link assembly of the presently preferred embodiment.

FIG. 11 depicts a sectional view of the link assembly of the presently preferred embodiment.

FIG. 12 depicts a sectional view of a shaft of a link assembly of an alternative embodiment.

FIG. 13 depicts a sectional view of a shaft of a link assembly of an alternative embodiment.

FIG. 14 depicts a sectional view of a shaft of a link assembly of an alternative embodiment.

FIG. 15 depicts a sectional view of a shaft of a link assembly of an alternative embodiment.

FIG. 16 depicts a sectional view of a shaft of a link assembly of an alternative embodiment.

FIG. 17 depicts a sectional view of a shaft of a link assembly of an alternative embodiment.

FIG. 18 depicts a sectional view of a link assembly of an alternative embodiment.

FIG. 19 depicts a sectional view of a link assembly of an alternative embodiment.

### DETAILED DESCRIPTION OF THE PRESENTLY PREFERRED EMBODIMENTS

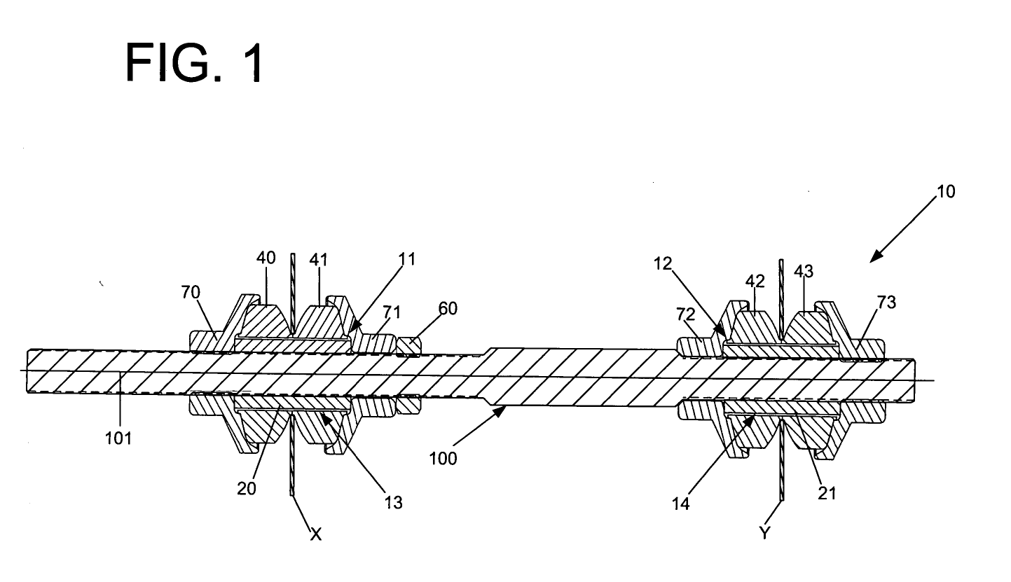

FIG. 1 depicts the link assembly 10 of the preferred embodiment provided with a first arm coupler 11, a second arm coupler 12, a positioning member 60, and a shaft 100. The first and second arm couplers 11, 12 are any structures that link the shaft 100 to an arm of a suspension system, such as, for example, but without limitation, a structure that includes a grommet or a ball joint. The first and second arm couplers 11, 12 of the presently preferred embodiment are respectively provided with a first interfacing assembly 13 and a second interfacing assembly 14.

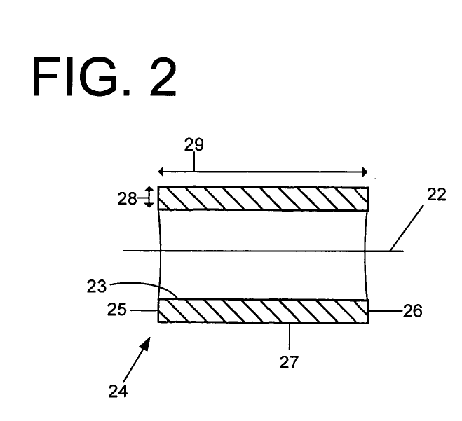

As shown in FIG. 1, the first and second interfacing assemblies 13, 14 of the preferred embodiment are respectively provided with a first interfacing member 20 and a second interfacing member 21. According to one aspect of the preferred embodiment, the interfacing members 20, 21 include a metal, preferably a steel to survive compression loads, and are provided with an axis 22. As shown in FIG. 2, the interfacing members 20, 21 are generally tubular in shape and provided with a plurality of surfaces. As depicted, the interfacing members 20, 21 are provided with an inner surface 23 that is generally cylindrical in shape and located radially about the axis 22. In the preferred embodiment, the inner surface 23 is unthreaded, however, in an alternative embodiment, the inner surface 23 is provided with threads configured to couple with the threads on the shaft 100.

As shown in FIG. 2, the inner surface 23 is located adjacent to an outer surface 24. The outer surface 24 of the preferred embodiment includes a plurality of surfaces. The outer surface 24 includes a first and second load limiting surfaces 25, 26. As shown in FIG. 2, the load limiting surfaces 25, 26 are located radially about the axis 22 and provided with a generally flat and annular in shape.

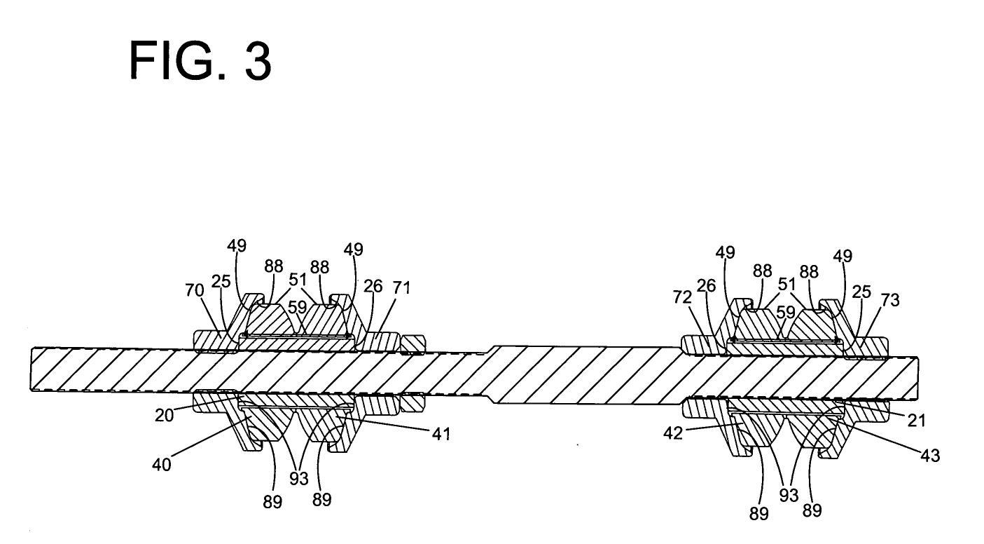

In the preferred embodiment, the first and second load limiting surfaces 25, 26 contact the grommet contacting members 70-73 when a predetermined axial load is exerted on the grommets 40-43. As shown in FIG. 3, the first load limiting surfaces 25 on the first and second interface members 20, 21 contact second contact surfaces 93 on respective first and second outer grommet contacting members 70, 73. Also shown therein, the second load limiting surfaces 26 on the first and second interfacing members 20, 21 contact second contact surfaces 93 on respective first and second inner grommet contacting members 71, 72. Advantageously, the contact between the first interface member 20 and the grommet contacting members 70, 71 limits the amount of the axial load exerted on the grommets 40-41 and contact between the second interface member 21 and the grommet contacting members 72, 73 limits the amount of the axial load exerted on the grommets 42-43. Advantageously, the contact prevents excessive torquing of outer grommet contacting members 70, 73 and over-compression of the grommets 40, 41.

Turning now again to FIG. 2, the first and second load limiting surfaces 25, 26 are located adjacent to a grommet contact surface 27. As shown in FIG. 2, the grommet contact surface 27 is generally cylindrical in shape and located radially about the axis 22.

As shown in FIG. 2, the interfacing members 20, 21 are provided with a thickness 28 that extends between the inner surface 23 and the grommet contact surface 27. In the preferred embodiment, the thickness 28 is dimensioned according to an axial load exerted on the interfacing members 20, 21 by the respective grommet contacting members 70, 71 and 72, 73. In the preferred embodiment the thickness 28 ranges from about 0.04 inches to about 0.38 inches and is preferably about 0.25 inches.

As further shown in FIG. 2, the interfacing members 20, 21 are provided with an axial length 29 extending between the first and second load limiting surfaces 25, 26. The axial length 29 is dimensioned according to the axial load exerted on the grommets 40-43. Advantageously, increasing the axial length 29 decreases the axial load and decreasing the axial length increases the axial load. In the preferred embodiment the axial length 29 ranges from about 1.5 inches to about 3.0 inches and is preferably about 1.75 inches.

Turning now again to FIG. 1, the first and second interfacing assemblies 13, 14 of the preferred embodiment are respectively provided with a first pair of grommets 40, 41 and a second pair of grommets 42, 43. The first pair of grommets 40, 41 includes a first outer grommet 40 and a first inner grommet 41 and the second pair of grommets 42, 43 includes a second inner grommet 42 and a second outer grommet 43.

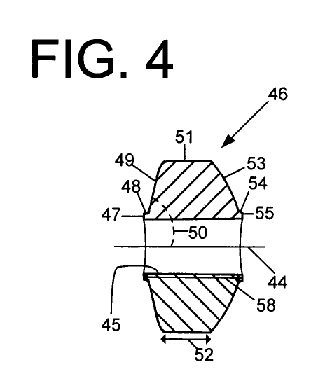

According to one aspect of the preferred embodiment, the grommets 40-43 include an elastomer material, such as a urethane or polyurethane, and are provided with an axis 44. As shown in FIG. 4, the grommets 40-43 are each provided with a grommet length 58. In the preferred embodiment, the grommet length 58 ranges from about 0.5 inches to about 1.25 inches and is preferably about 0.75 inches. Also, shown in FIG. 3, the first pair of grommets and the second pair of grommets are provided with a grommet pair length 59. In the preferred embodiment, the grommet pair length 59 ranges from about 1.0 inches to about 2.5 inches and is preferably about 1.5 inches.

The grommets 40-43 are provided with a plurality of surfaces. As shown in FIG. 4, the grommets 40-43 are provided with an inner surface 45. The inner surface 45 of the grommets 40-43, is dimensioned to receive the grommet contact surface 27 of the interfacing members 20, 21. In the preferred embodiment depicted in FIG. 3, the first pair of grommets 40, 41 receives the first interfacing member 20 and the second pair of grommets 42, 43 receives the second interfacing member 21. The inner surface 45 of the preferred embodiment is generally cylindrical in shape and located radially about the axis 44.

The inner surface 45 is located adjacent to an outer surface 46. According to one aspect of the preferred embodiment, the outer surface 46 is shaped to accommodate the motion of an arm X such as a suspension arm. The outer surface 46 in FIG. 4 is also shaped to accommodate the motion of a torsion rod arm Y. In the preferred embodiment, the outer surface 46 includes a plurality of surfaces, however, in alternative embodiments, the outer surface 46 is shaped generally spherical or conical depending on the motion and shape of an arm, such as a suspension arm X or a torsion rod arm Y.

As shown in FIG. 4, the outer surface 46 is provided with a first spacing surface 47 that is located radially about the axis 44 and provided with a generally flat and annular shape. In the preferred embodiment, the spacing surface 47 is located adjacent to a first lip 48. As shown in FIG. 4, the first lip 48 is preferably generally frustoconical in shape and located radially about the axis 44.

The first lip 48 is preferably located adjacent to a load receiving surface 49. As shown in FIG. 4, the load receiving surface 49 is located radially about the axis 44. According to one aspect of the preferred embodiment, the load receiving surface 49 is shaped to accommodate the motion of an arm, such as a suspension arm X or a torsion rod arm Y. According to another aspect of the preferred embodiment, the load receiving surface 49 is shaped to accept an axial load from the first contact surface 89 of one of the grommet contacting members 70-73. As shown in FIG. 3, the load receiving surfaces 49 on the first outer and inner grommets 40, 41 contact and accept an axial load from the first contact surfaces 89 of the respective first outer and inner grommet contacting members 70, 71. Also shown therein, the load receiving surfaces 49 on the second inner and outer grommets 42, 43 contact and accept an axial load from the first contact surfaces 89 of the respective second inner and outer grommet contacting members 72, 73. Advantageously, the axial load compresses the first pair of grommets 40, 41 together and the second pair of grommets 42, 43 together.

As depicted in FIG. 4, the load receiving surface 49 is preferably generally frustoconical in shape and at an angle 50 with respect to the axis 44. In the preferred embodiment the angle 50 ranges from about 74° to about 79° and is preferably about 77°. While the preferred embodiment is provided with a generally frustoconical load receiving surface 49, in alternative embodiments, the load receiving surface 49 is generally curved in shape, such as, for example, by being generally convex in shape.

In the preferred embodiment, the load receiving surface 49 is located adjacent to an expanding surface 51, which links the load receiving surface 49 to an arm engaging surface 53. According to one aspect of the preferred embodiment, the expanding surface 51 is shaped to expand radially with respect the axis 44 as the grommets 40-43 are compressed. As shown in FIG. 4, the expanding surface 51 of the preferred embodiment is generally cylindrical in shape and located radially about the axis 44. The expanding surface 51 is provided with a length 52 dimensioned according to the axial load exerted by the first contact surface 89 of the grommet contacting members 70-73. The length 52 shown in FIG. 4 is also dimensioned according to the radial load exerted by a covering surface 88 on the grommet contacting members 70-73. In the preferred embodiment the length ranges from about 0.5 inches to about 1.5 inches and is preferably about 0.75 inches.

The expanding surface 51 is preferably located adjacent to the arm engaging surface 53. According to one aspect of the preferred embodiment, the arm engaging surface 53 is preferably shaped to accommodate the motion of an arm, such as a suspension arm X or a torsion rod arm Y. According to another aspect of the preferred embodiment, the arm engaging surface 53 is configured to engage an arm, such as suspension arm X, or a torsion rod arm Y.

As shown in FIG. 4, the arm engaging surface 53 is located radially about the axis 44 and provided with a generally curved in shape, preferably a generally convex shape. While the preferred embodiment is provided with a generally curved arm engaging surface 53, in alternative embodiments, the arm engaging surface 53 is generally frustoconical in shape and at an angle with respect to the axis 44.

In the preferred embodiment, the arm engaging surface 53 is located adjacent to a second lip 54. In the preferred embodiment, the second lip 54 of the grommets 40, 41 and 42, 43 are configured to be located within an aperture of an arm, such as the aperture on a suspension arm or the aperture on a torsion rod arm. As shown in FIG. 4, the second lip 54 is generally frustoconical in shape and located radially about the axis 44.

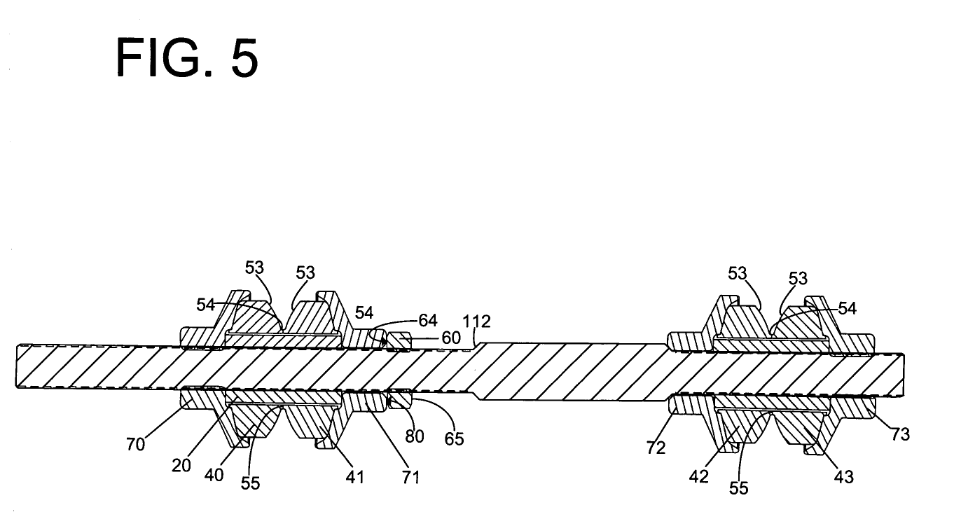

Located adjacent to the second lip 54 is a second spacing surface 55. As shown in FIG. 4, the second spacing surface 55 is located radially about the axis 44 and is generally flat and annular in shape. As shown in FIG. 5, the second spacing surfaces 55 of the grommets 40, 41 and 42, 43 preferably contact each other.

Turning now again to FIG. 1, the first and second arm couplers 11, 12 of the preferred embodiment are respectively provided with a first pair of grommet contacting members 70, 71 and a second pair of grommet contacting members 72, 73. The first pair of grommet contacting members 70, 71 includes a first outer grommet contacting member 70 and a first inner grommet contacting member 71 and the second pair of grommet contacting members 72, 73 includes a second outer grommet contacting member 73 and a second inner grommet contacting member 72.

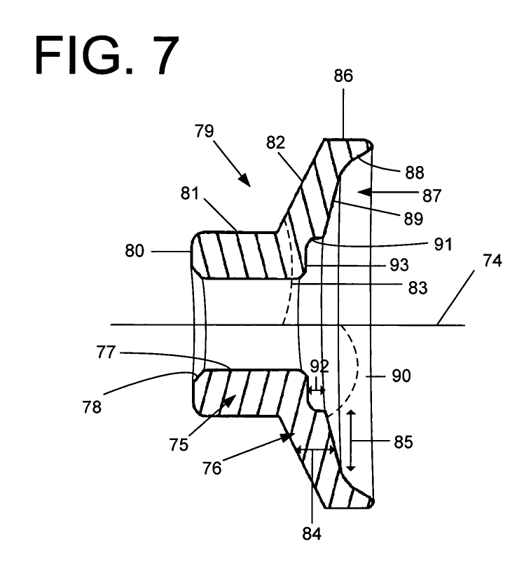

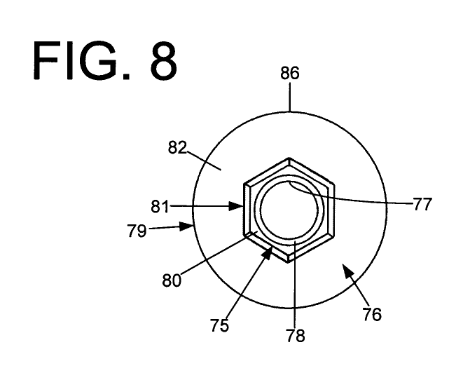

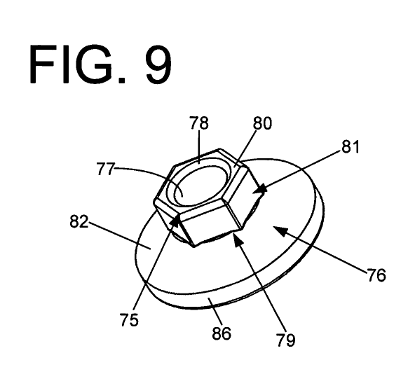

According to one aspect of the preferred embodiment, the grommet contacting members 70-73 include a metal, preferably a steel, and are provided with an axis 74. As shown in FIGS. 7, 8, and 9, the grommet contacting members 70-73 are provided with a shaft receiving element 75 and a flange element 76. Advantageously, the flange element 76 extends radially from the shaft receiving element 75 and is dimensioned to withstand loads generated by either the suspension arm X, or a torsion rod arm Y. According to one aspect of the preferred embodiment, the flange element 76 is configured to prevent the grommet contacting members 75-78 from backing off the shaft 100 as a result of the motion of an arm, such as suspension arm X or torsion rod arm Y. According to another aspect of the preferred embodiment, the flange element 76 is configured to prevent the stretching or distortion of the shaft 100 as a result of the motion of an arm. Advantageously, the flange element 76 is configured to act as a washer or spring in response to the motion of an arm. The flange element 76 is configured to resiliently flex in response to forces generated by the motion of an arm.

As shown in FIG. 7, the shaft receiving element 75 is located radially about the axis 74. In the preferred embodiment, the shaft receiving element 75 and the flange element 76 are fabricated integrally, however, in alternative embodiments the shaft receiving element 75 and the flange element 76 are separate components or rotatably assembled together. In one such alternative embodiment, the shaft receiving element 75 is a nut, such as a hexagon shaped nut, and the flange element 76 is a washer, such as a Bellville washer.

As further depicted in FIGS. 7, 8, and 9, the grommet contacting members 70-73 include an inner surface 77 located on the shaft receiving element 75. In the preferred embodiment, the inner surface 77 is dimensioned according to the first diameter 108 of the shaft 100 so that the grommet contacting member does not move radially. Advantageously, inner surface 77 is dimensioned so that the axis 74 of the grommet contacting members 70-73 and the axis 101 of the shaft 100 are substantially coaxial. As shown in FIG. 7, the inner surface 75 is generally cylindrical in shape and located radially about the axis 74.

In the preferred embodiment, the outer grommet contacting members 70, 73 are provided with an inner surface 75 that includes threads (not shown) and the inner grommet contacting members 71, 72 are provided with an inner surface 75 that is unthreaded. However, in an alternative embodiment, the inner grommet contacting members 71, 72 are provided with an inner surface 75 that includes threads. In a further alternative embodiment, the inner surface 75 of the grommet contacting members 70-73 includes threads and a nylon insert.

As shown in FIGS. 7, 8, and 9, the inner surface 77 is located adjacent to an outer surface 79. In the preferred embodiment, the outer surface 79 includes the end surface 80. In the preferred embodiment, the end surface 80 is located on the shaft receiving element 75 adjacent to the inner surface 77. The end surface 80 is preferably generally flat and annular in shape. As shown in FIGS. 7, 8, and 9, the end surface 80 is preferably provided with at least one chamfer 78. As shown therein, the end surface 80 is located radially about the axis 74.

In the preferred embodiment, the end surface 80 is located radially about the axis 74 adjacent to a torque transmitter 81 on the shaft receiving element 75. The torque transmitter 81 is any surface which is shaped to receive torque, but preferably in the shape of a polygon, such as a hexagon. Although the inner grommet contacting members 71-72 of the preferred embodiment are provided with a torque transmitter 81, in alternative embodiments, the torque transmitter 81 on the inner grommet contacting members 71, 72 is absent or substituted with another surface, such as for example a cylindrical surface.

The torque transmitter 81 is located adjacent to a corresponding surface 82. As shown in FIGS. 7, 8, and 9, the corresponding surface 82 is located on the flange element 76 and radially about axis 74. According to one aspect of the preferred embodiment, the corresponding surface 82 is shaped according to the grommets 40-43. According to another aspect of the preferred embodiment, the shape of the corresponding surface 82 corresponds to the load receiving surface 49 on the grommets 40-43. As shown in FIG. 7, the corresponding surface 82 is generally frustoconical in shape and at an angle 83 with respect to axis 74. The angle 83 is generally the same as the angle 50 of the load receiving surface 49 on the grommets 40-43. In the preferred embodiment the angle 83 ranges from about 45° to about 90° and is preferably about 58°.

According to yet another aspect of the preferred embodiment, the corresponding surface 82 is contoured according to a grommet cooperating surface 87 on the grommet contacting members 70-73. According to still another aspect of the preferred embodiment, the corresponding surface 82 is shaped according to a thickness 84 of the grommet contacting members 70-73 located between the corresponding surface 82 and a grommet cooperating surface 87. As shown in FIG. 7, the corresponding surface 82 is shaped so that the thickness 84, along a length 85 of the first contact surface 89, is generally uniform and dimensioned so that the flange element 79 acts as a washer or spring. In the preferred embodiment the thickness 84 ranges from about 0.06 inches to about 0.75 inches and is preferably about 0.31 inches.

In the preferred embodiment, the corresponding surface 82 is located adjacent to a connecting surface 86, which connects the corresponding surface 82 to the grommet cooperating surface 87. The connecting surface 86 is located on the flange element 76 radially about the axis 74. As shown in FIGS. 7, 8, and 9, the connecting surface 86 of the preferred embodiment is generally cylindrical in shape.

The grommet cooperating surface 87 is located on the flange element 76 radially about the axis 74 adjacent to the connecting surface 86. As shown in FIG. 7, the grommet cooperating surface 87 is provided with a covering surface 88. As shown therein, the covering surface 88 is located adjacent to the connecting surface 86 and radially about the axis 74. As depicted in FIG. 7, the covering surface 88 is provided with a curved shape, preferably a generally concave shape.

Advantageously, the covering surface 88 controls, and preferably limits, the radial expansion of the grommet 40-43 when the grommets 40, 41 and 42, 43 are compressed by the grommet contacting members 70-73. As shown in FIG. 3, the covering surface 88 is configured to cover at least the expanding surface 51 of one of the grommets 40-43. The covering surface 88 exerts a radial load on the grommets 40-43 as the grommets 40-43 expand radially under compression.

The grommet cooperating surface 87 of the preferred embodiment is provided with a first contact surface 89 located adjacent to the covering surface 88. According to one aspect of the preferred embodiment, the first contact surface 89 is configured to exert an axial load on the load receiving surface 49 of the grommets 40, 43. Advantageously, the first contact surface 89 of the first and second pairs of grommet contacting members 70, 71 and 72, 73 members respectively compresses the first and second pairs of grommets 40, 41 and 42, 43 together.

According to another aspect of the preferred embodiment, the first contact surface 89 is contoured according to the grommets 40-43, preferably to evenly distribute an axial load on the grommets 40-43. According to another aspect of the preferred embodiment, the first contact surface 89 is contoured to locate and fix in place the grommets 40-43 on the interfacing members 20, 21. In the preferred embodiment, the shape of the first contact surface 89 corresponds to the load receiving surface 49 on the grommets 40-43.

As shown in FIG. 7, the first contact surface 89 is located radially about the axis 74 and is generally frustoconical in shape. As shown, the first contact surface 89 is at an angle 90 with respect to axis 74. The angle 90 preferably measures generally the same as the angle 50 of the load receiving surface 49 on the grommets 40-43. In the preferred embodiment the angle 90 ranges from about 74° to about 79° and is preferably about 77°.

In the preferred embodiment, the grommet cooperating surface 87 is located adjacent to an offsetting surface 91. As shown in FIG. 7, the offsetting surface 91 is located radially about the axis 74 adjacent to the first contact surface 89 on the grommet cooperating surface 87. As depicted in FIG. 7, the offsetting surface 91 is provided with a curved shape, preferably a generally concave shape.

Advantageously, the offsetting surface 91 is contoured to prevent radial movement of the interfacing members 20, 21 about the axis 101 of the shaft 100. Advantageously, offsetting surface is contoured so that the axis 22 of the interfacing members 20, 21 and the axis 101 of the shaft 100 are substantially coaxial. In the preferred embodiment, the offsetting surfaces 91 of the grommet contacting members 70, 71 and 72, 73 extends radially about at least a portion grommet contact surfaces 27 on the respective interfacing members 20 and 21. According to another aspect of the preferred embodiment, the offsetting surfaces 91 of the grommet contacting members 70, 71 and 72, 73 preferably contact and extend radially about at least a portion of the first lips 48 of the respective grommets 40, 41 and 42, 43.

In the preferred embodiment, the offsetting surface 91 is located adjacent to the second contact surface 93. The second contact surfaces 93 accommodate at least one of the interfacing members 20, 21. Advantageously, the second contact surface 93 is contoured to locate and fix in place at least one of the interfacing members 20, 21 on the shaft 100. Advantageously, the second contact surfaces 93 contact the interfacing members 20, 21 when a predetermined axial load is exerted on the grommets 40-43. As shown in FIG. 7, the second contact surface 93 is located on the shaft receiving element 75 radially about the axis 74 and preferably generally flat and annular in shape.

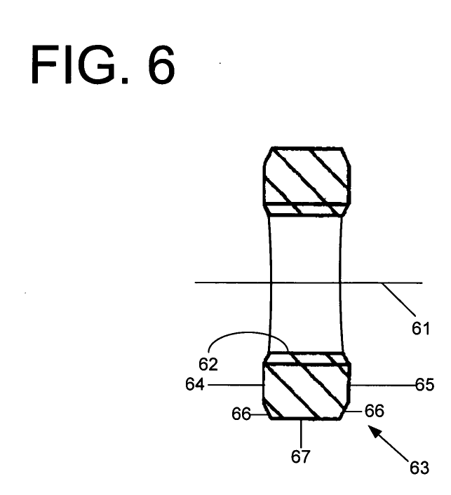

Turning now again to FIG. 1, the link assembly 10 is preferably provided with at least one positioning member 60 that includes a metal, preferably a steel, and is provided with an axis 61. As shown in FIG. 6, the positioning member 60 is provided with an inner surface 62 located radially about the axis 61. In the preferred embodiment, the inner surface 62 is generally cylindrical in shape and provided with threads (not shown). In an alternative embodiment, the inner surface 62 is provided with a nylon insert.

The inner surface 62 is located adjacent to an outer surface 63. As shown in FIG. 6, the outer surface 46 preferably includes a first positioning surface 64 and a second positioning surface 65 that extend radially about the axis 61. In the preferred embodiment, the positioning surface 64, 65 are generally flat and annular in shape and provided with a chamfer 66. As shown in FIG. 5, the first positioning surface 64 is contoured to contact an end surface 80 on the inner grommet contacting member 41 to position the inner grommet contacting member 41 within the first positioning surface 101 of the shaft 100. In the preferred embodiment, the second positioning surface 65 is contoured to contact a first lead surface 112 on the shaft 100 to limit the axial movement of positioning member 60 along the first positioning surface 101 of the shaft 100.

In the preferred embodiment, the first and second positioning surface 65, 65 are located adjacent to a torque transmitter 67. The torque transmitter 67 is any surface which is shaped to receive torque, such as, for example, a polygon. In the preferred embodiment, the torque transmitter 67 is in the shape of a hexagon and located radially about the axis 61.

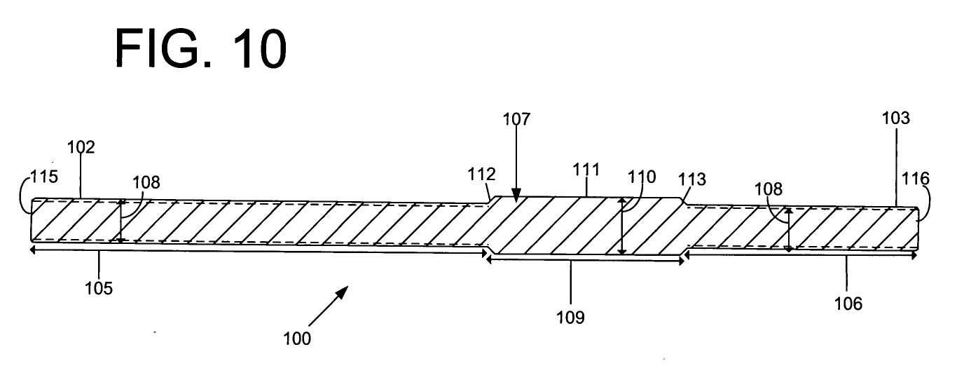

Turning now again to FIG. 1, the link assembly 10 is provided with a shaft 100 that includes a metal, preferably a steel, and an axis 101. As shown in FIG. 10, the shaft 100 is generally cylindrical in shape and preferably provided with a first positioning surface 102 and a second positioning surface 103, which are provided with a first diameter 108 and threads. In an alternative embodiment, the threads are a locking thread, such as that disclosed in the United States patent application entitled “Fastener Assembly,” application Ser. No. 09/933,312, the disclosure of which is hereby incorporated herein by reference.

The positioning surfaces 102, 103 are located radially about the axis 101 and generally cylindrical in shape. In the embodiment depicted, the first positioning surface 102 is provided with a length 105 and is located between a first end 115 of the shaft 100 and a spacer section 107. The length 106 is preferably dimensioned according to the grommet length 58 and the grommet pair length 59. The length 106 ranges from about 3 to about 12 times greater than the grommet length 58 and is preferably about 8 times greater than the grommet length 58. The length 106 ranges from about 1.5 times to about 6 times greater than the grommet pair length 59 and is preferably about 4 times greater than the grommet pair length 59. In the preferred embodiment the length 105 ranges from about 3.0 inches to about 8.0 inches and is preferably 5.0 inches. The second positioning surface 103 is provided with a length 106 and is located between a second end 116 and the spacer section 107. In the preferred embodiment the length 106 is smaller than the length 105. Length 106 ranges from about 2.5 inches to about 7.0 inches and is preferably 4.0 inches.

Included within the shaft 100 is preferably the spacer section 107 that is located adjacent to the first and second positioning surfaces 102, 103. The spacer section 106 is generally cylindrical in shape and located radially about the axis 101. As depicted in FIG. 10, the spacer section 107 is provided with length 109 and a second diameter 110. In the preferred embodiment, the length 109 and the second diameter 110 are dimensioned so that the shaft 100 is provided with increased resistance to tension, compression, bending, and torsional forces. As shown in FIG. 10, the second diameter 110 of the shaft 100 is preferably larger than the first diameter 108 of the shaft 100.

The spacer section 107 of the preferred embodiment is provided with a plurality of surfaces. As shown in FIG. 10, the spacer section is provided with a strengthening surface 111, which is located radially about the axis 101 and preferably generally cylindrical in shape. The strengthening surface 111 is preferably provided with the second diameter 110. As shown in FIG. 10, the strengthening surface 111 is preferably located adjacent to a plurality of lead surfaces 112, 113 located radially about the axis 101. In the preferred embodiment, the first and second lead surfaces 112, 113 are provided as generally frustoconical surfaces and are spaced by length 109.

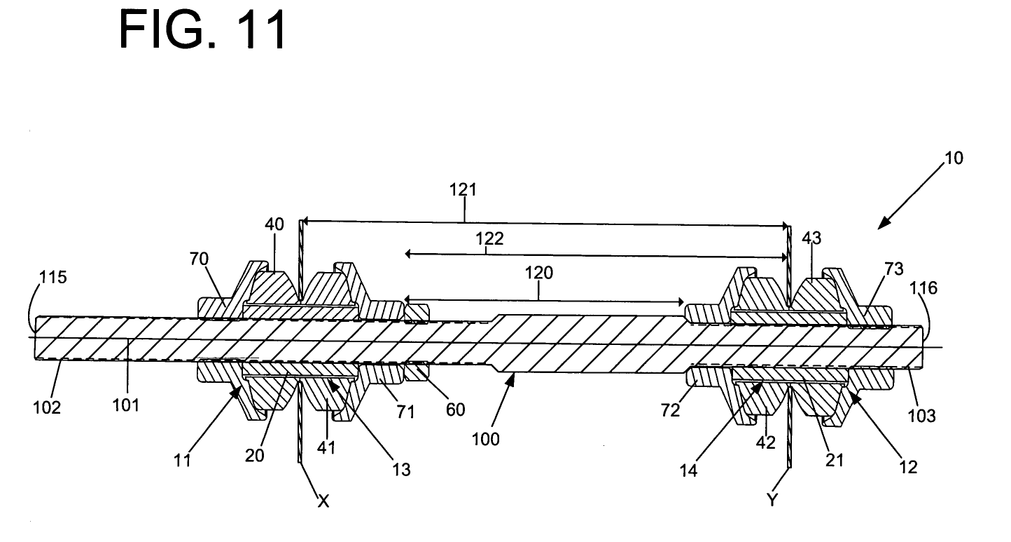

According to one aspect of the preferred embodiment, the interfacing members 20, 21, the positioning member 60, and the grommet contacting members 70-73 receive the shaft 100. Advantageously, the first diameter 108 of the shaft 100 is dimensioned so that the inner surfaces 23, 62, and 77, respectively located on the interfacing members 20, 21, the positioning member 60, receive the shaft 100. As shown in FIG. 11, the grommets 40-43 extend radially about the shaft 100 and the grommets 40, 41 and 42, 43 preferably extend radially about the respective interfacing members 20, 21.

As shown in FIG. 11, the second pair of grommet contacting members 72, 73 and the second interfacing member 21 receive the second positioning surface 103 of the shaft 100. Initially, the second inner grommet contacting member 72 slidably receives the shaft 100 and travels axially toward the first end 115 of the shaft 100. Thereafter, the second interfacing member, along with the second inner grommet 42 located around the grommet interface surface 27, slidably receives the shaft 100. Thereafter the shaft 100 is positioned so that an aperture of an arm receives the second positioning surface 103 of the shaft. Then the second outer grommet 43 is positioned onto the grommet interface surface 27 of the second interfacing member 21, whereby the second inner grommet 42 contacts one side of an arm, such as torsion rod arm Y, and the second outer grommet 43 contacts the other side of the arm.

Thereafter, the second outer grommet contacting member 73 receives the second positioning surfaces 103 and the threads thereon couple with the threads on the second positioning surface 103. Then torque is applied to the second outer grommet contacting member 73, preferably on the torque transmitter 81. The application of torque results in the second outer grommet contacting member 73 traveling towards the first end 115 of the shaft 100. Eventually, the second outer grommet contacting member 73 positions the second inner grommet contacting member 72 so that the end surface 80 thereon contacts the second lead surface 113.

Further continued movement of the outer grommet contacting member 73 towards the first end 115 positions the second interfacing member 21 on the shaft 100 and the grommets 42, 43 on the second interfacing member 21 and the shaft 100. Eventually, the first contact surfaces 89 of the grommet contacting members 72, 73 contacting the load receiving surfaces 49, of the respective grommets 42, 43. Thereafter, the second inner grommet contacting member 72 continues to move toward the first end 115, and as this occurs, the grommet contacting members 72, 73 exert axial loads on the respective grommets 42, 43, which become compressed.

As the grommets 42, 43 are compressed, the expanding surfaces 51 on the grommets 42, 43 begin to expand radially outward from the axis 44. The expansion continues until contact occurs between the expanding surfaces 51 and the controlling surfaces 88. Thereafter, further radial expansion of the grommets 42, 43 is limited by the controlling surfaces 88. Advantageously, the controlling surfaces 88 exert a radial load on the grommets 42, 43 which limits the radial expansion of the grommets 42, 43.

As the second outer grommet contacting member 73 continues to travel toward the first end 115, the grommets 42, 43 continue to be compressed until a predetermined axial load is exerted on the grommets 42, 43. Once the predetermined axial load is exerted, the second contact surfaces 93 on the grommet contacting members 72,73 contact the respective first and second load limiting surfaces 25, 26 on the second interfacing member 21. Thereafter, the second interfacing member 21 substantially prevents further movement of the outer grommet contacting member 73 towards the first end 115 and substantially prevents further compression of the grommets 42, 43.

Advantageously, the positioning member 60 can be adjustably positioned along the shaft 100, preferably within the first positioning surface 102 of the shaft 100. As shown in FIG. 11, in the preferred embodiment, the positioning member 60 selectively positions the first arm coupler 11 within the first positioning surface 102 of the shaft 100. The positioning member 60 contacts and positions the inner grommet contacting member 70 on the shaft 100, which, in turn, cooperates with the outer grommet contacting member 71 to position the first interface member 20 on the shaft 100. By adjustably positioning the positioning member 60, the first arm coupler 11 and the first pair of grommets 40, 41 can be selectively positioned at a plurality of locations on the first positioning surface 102 and a plurality of axial distances, such as axial distance 120, can be provided between the first and second arm couplers 11, 12. Thus, the link assembly 10 is adapted for use with a plurality of different vehicle models, wherein the axial distance, such as 121 shown in FIG. 11, between arms of the vehicle, such as suspension arm X and torsion rod arm Y, will vary from vehicle model to vehicle model. As shown in FIG. 11 a plurality of axial distances, such as 122, can be provided between the first arm coupler 11 and the arm of a vehicle, such as torsion rod arm Y.

In the preferred embodiment, as shown in FIG. 11, the first pair of grommet contacting members 70, 71, the first interfacing member 21 and the positioning member 60 receives the first positioning surface 102 of the shaft 100. Initially, the positioning member 60 receives the first positioning surface 102 and the threads thereon couple with the threads on the first positioning surface 102. Thereafter, the first inner grommet contacting member 71, the first interfacing member 20, and the first outer grommet contacting member 70 receive the first positioning surface 102 and cooperate with another arm, such as arm X, in much the same manner as the respective second inner grommet contacting member 72, the second interfacing member 21, and the second outer grommet contacting member 73 receive the second positioning surface 103 and cooperate with an arm, such as arm Y. However, instead of the end surface 80 on the second inner grommet contacting member 72 contacting the first lead surface 112, it contacts the first positioning surface 64 on the positioning member 60. Advantageously, since the positioning member 60 can be positioned anywhere along the length 105 of the first positioning surface 102, the link assembly 10 can be utilized on a multitude of different vehicle models, without having to tailor the shaft 100 to suit a particular vehicle model.

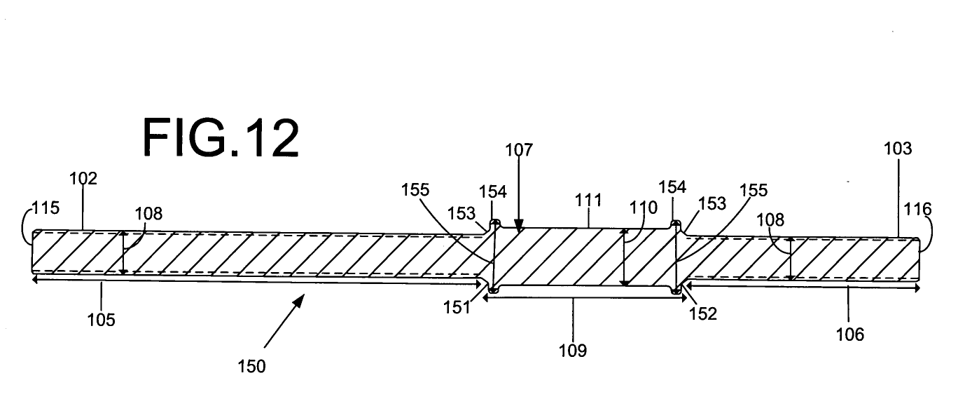

Turning now to FIG. 12, an alternative embodiment of the shaft 100 is depicted at 150. The shaft 150 is identical to shaft 100, except for the presence of modified lead surfaces 112, 113, which are respectively depicted at 151, 152. As shown therein, the lead surfaces 151, 152 are provided with a frustoconical surface 153 and an upset surface 154. The frustoconical surfaces 153 on the lead surfaces 151, 152 are respectively located adjacent to the first positioning surface 102 and the second positioning surface 103. Each upset surface 154 is located adjacent to a frustoconical surface 153 and the strengthening surface 111. As shown in FIG. 12, the upset surfaces 154 are provided with a third diameter 155, which is larger than the first and second diameters 108, 110.

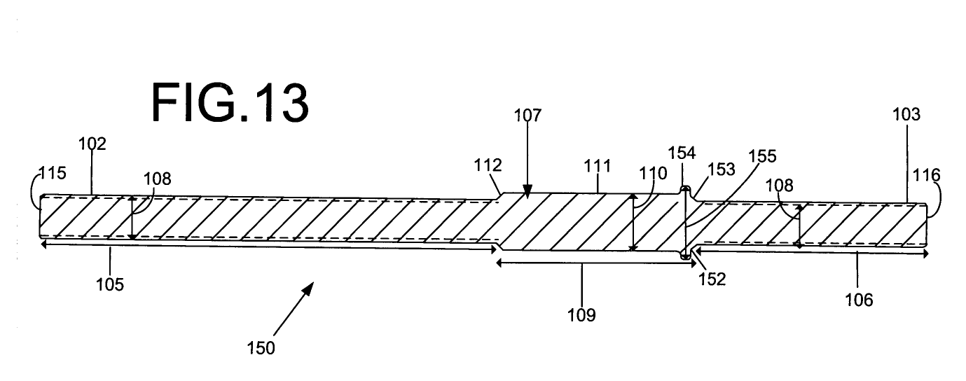

Although FIG. 12 depicts the shaft 150 provided with two modified lead surfaces, 151, 152, in further alternative embodiments the shaft 150 is provided with the lead surface 112 and lead surface 152 or lead surface 151 and lead surface 113. By way of example, FIG. 13, depicts the shaft 150 provided with the lead surface 112 and the lead surface 152.

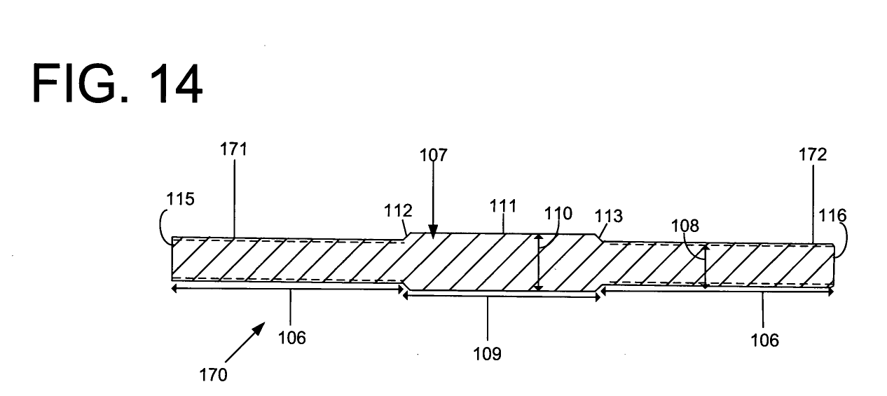

Turning now to FIG. 14 another embodiment of the shaft 100 is depicted at 170. The shaft 170 is identical to the shaft 100, except for the presences of modified first and second positioning surfaces 102, 103, which are respectively depicted at 171, 172. As shown therein, the first and second positioning surfaces 171, 172 are each provided with the length 106.

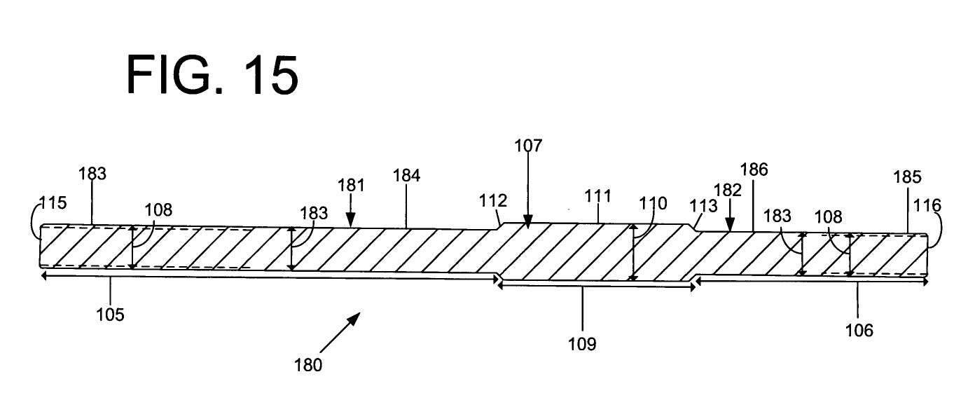

Turning now to FIG. 15, another embodiment of the shaft 100 is depicted at 180. The shaft 180 is identical to the shaft 100, except for the presence of modified first and second positioning surfaces 102, 103, which are respectively depicted at 181, 182. In the embodiment depicted, the first positioning surface 181 is provided with a first threaded surface 183 and a first unthreaded surface 184 and the second positioning surface 182 is provided with a second threaded surface 185 and a second unthreaded surface 186. The first threaded surface 183 is located between the first end 115 of the shaft 180 and the first unthreaded surface 184. The first unthreaded surface 184 is located between the first threaded surface 183 and the first lead surface 112. The second threaded surface 185 is located between the second end 116 of the shaft 180 and the second unthreaded surface 186. The second unthreaded surface 186 is located between the second threaded surface 185 and the second lead surface 113. As shown in FIG. 15, the surfaces 184, 186 are provided with the diameter 183. The diameter 183 is substantially equal to the diameter 108 of the threaded surfaces 183, 185.

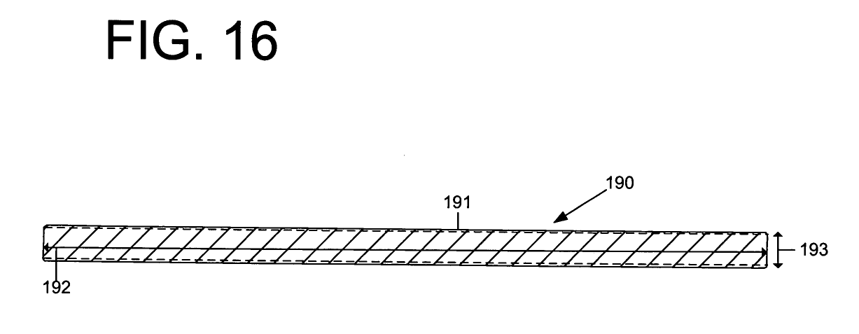

Turning now to FIG. 16, an alternative embodiment of the shaft 100 is depicted at 190. The shaft 190 is identical to the shaft 100, except that the shaft 190 is provided with a positioning surface 191 that extends substantially along the entire length 192 of the shaft 190 and a substantially uniform diameter 193 along the length 192 of the shaft 190. In yet another alternative embodiment, the shaft 190 is included on a bolt, which further includes a head configured to accept torque, such as for example a hexagon shaped head.

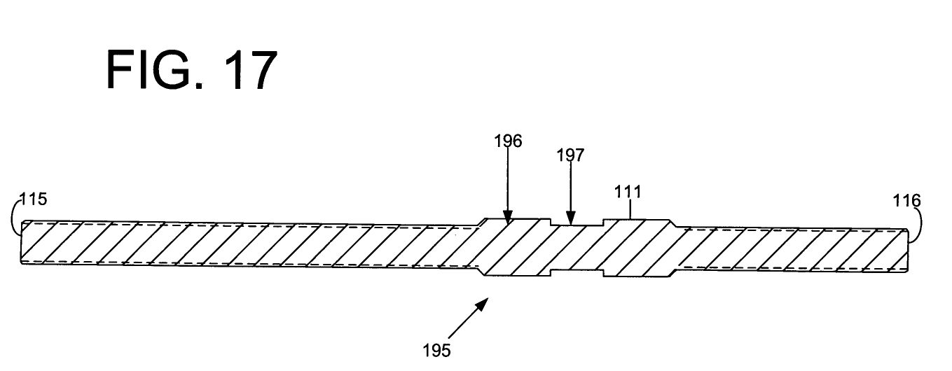

Turning now to FIG. 17, yet another alternative embodiment of the shaft 100 is depicted at 195. The shaft 195 is identical to the shaft 100, except that the shaft 195 is provided with a modified form of the spacer section 107, which is depicted at 196. The spacer section 196 is identical to the spacer section 107, except the spacer section 196 is provided with a torque transmitter 197. The torque transmitter 197 is any shape that is configured to transfer torque to the shaft 195. In the embodiment depicted, the torque transmitter 197 is provided as a plurality of flats, which are arranged in the shape of a polygon, preferably a hexagon. Although in FIG. 17 the torque transmitter 197 is located within the spacer section 196, in yet another alternative embodiment, the shaft 195 is provided with a torque transmitter 197 that is in the shape of a socket, such as an internal or external socket, and is located on at least one of the first and second ends 115, 116 of the shaft 195.

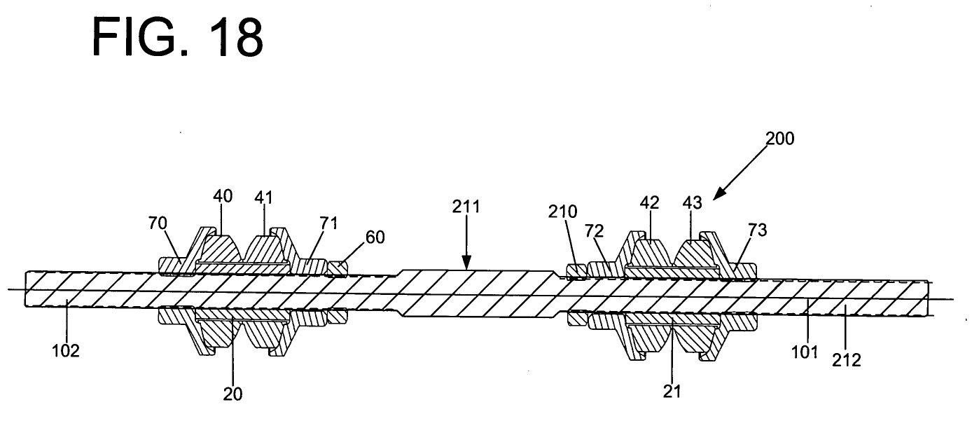

Turning now to FIG. 18, an alternative embodiment of the link assembly 10 is depicted at 200. The link assembly 200 is identical to the link assembly 10, except for the presence of a second positioning member 210 and a modified form of the shaft 100, which is depicted at 211. The shaft 211 is identical to the shaft 100 except for the presence of a modified form of the second positioning surface 103, which is depicted at 212. The second positioning surface 212 is identical to the second positioning surface 103, except the second positioning surface 212 is provided with length 105 instead of length 106.

In the embodiment depicted in FIG. 18, the positioning member 60, or first positioning member 60, cooperates with the first inner grommet contacting member 71 and the first positioning surface 102 in the same manner as previously described. The second positioning member 210 is identical to the first positioning member 60 and cooperates with the second positioning surface 212 and the second inner grommet contacting member 72 in the same manner as the first positioning member 60 cooperates with the first positioning surface 102 and the first inner grommet contacting member 71.

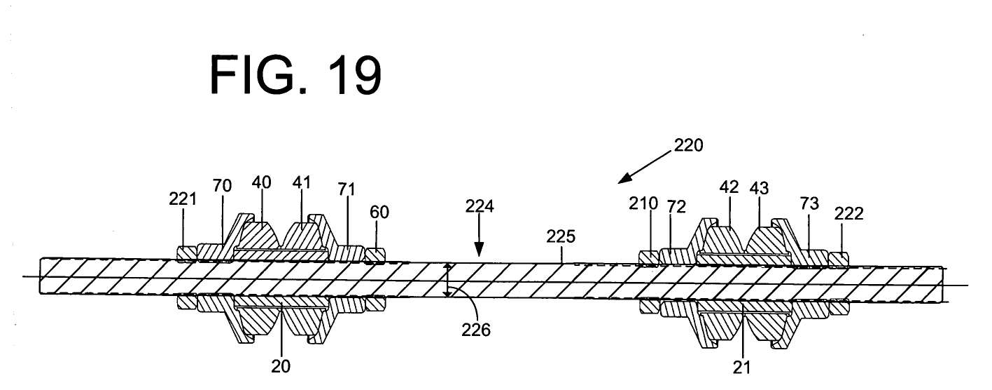

Turning now to FIG. 19, another alternative embodiment of the link assembly 200 (shown in FIG. 18) is depicted at 220. The link assembly 220 is identical to the link assembly 200, except for the presence of third and fourth positioning members 221, 222 and a modified form of the stud shaft 211, which is depicted at 224. The stud shaft 224 is identical to the stud shaft 211 except for presence of a modified form of the spacer section 107, which is depicted at 225. As shown therein, the spacer section 225 is provided with a diameter 226 instead of diameter 110. The diameter 226 preferably measures less than the diameter 108 of the first and second positioning surfaces 102 and 212.

In the embodiment depicted in FIG. 19, the positioning member 60, or first positioning member 60, cooperates with the first positioning surface 102 and the first inner grommet contacting member 71 in the same manner as previously described. The second, third, and fourth positioning members 210, 221, 222 are identical to the positioning member 60. The second positioning member 210 cooperates with the second positioning surface 212 and the second inner grommet contacting member 72 in the same manner as the first positioning member 60 cooperates with the first positioning surface 102 and the first inner grommet contacting member 71. The third positioning member 221 cooperates with the first positioning surface 102 and the first outer grommet contacting member 70 in the substantially same manner as the first positioning member cooperates with the first positioning surface 102 and the first inner grommet contacting member 71. The fourth positioning member 222 cooperates with the second positioning surface 212 and the second outer grommet contacting member 73 in substantially the same manner first positioning member 60 cooperates with the first positioning surface 102 and the first inner grommet contacting member 71. In the embodiment depicted, the inner surface 77 of the first and second outer grommet contacting members 70, 73 are threaded, however, in another alternative embodiment, the inner surfaces 77 thereof are unthreaded.

While this invention has been particularly shown and described with references to preferred embodiments thereof, it will be understood by those skilled in the art that various changes in form and details may be made therein without departing from the spirit and scope of the invention as defined by the appended claims.

1. A link assembly for a vehicle suspension system comprising:
a) a shaft provided with a positioning surface that includes threads;
b) an arm coupler including an interfacing assembly and a pair of grommet contacting members, wherein;
i) the interfacing assembly includes an interfacing member that receives the positioning surface and inner and outer grommets that are provided with inner surfaces that receive the interfacing member; and
ii) the pair of grommet contacting members includes an inner grommet contacting member that receives the positioning surface shaft and contacts the inner grommet and an outer grommet contacting member that receives the positioning surface and contacts the outer grommet.

2. A link assembly for a vehicle suspension system according to claim 1, wherein:
a) the inner grommet contacting member exerts an axial load on the inner grommet and contact between the inner grommet contacting member and the interfacing member limits an amount of the axial load exerted on the inner grommet; and
b) the outer grommet contacting member exerts an axial load on the outer grommet and contact between the outer grommet contacting member and the interfacing member limits an amount of the axial load exerted on the outer grommet.

3. A link assembly for a vehicle suspension system according to claim 1, wherein:
a) the inner and outer grommets are provided with an axis and include a load receiving surface, an arm engaging surface, and an expanding surface, wherein:
i) the expanding surface is located between the load receiving surface and the arm engaging surface and configured to expand radially outward with respect to the axis;
ii) the load receiving surface on the inner grommet is configured to contact the inner grommet contacting member and the load receiving surface on the outer grommet is configured to contact the outer grommet contacting member;
iii) the arm engaging surfaces on the inner and outer grommets are configured to contact an arm of a vehicle suspension system;
b) the inner grommet contacting member includes a controlling surface that contacts the expanding surface on the inner grommet and limits the radial expansion of the inner grommet; and
c) the outer grommet contacting member includes a controlling surface that contacts the expanding surface on the outer grommet and limits the radial expansion of the outer grommet.

4. A link assembly for a vehicle suspension system according to claim 1, further comprising a bolt that includes the shaft and a head.

5. A link assembly for a vehicle suspension system according to claim 1, wherein first inner and outer grommet are provided with a grommet pair length and the first positioning surface is provided with a length that measures from about 1.5 to about 6 times greater than the grommet pair length.

6. A link assembly for a vehicle suspension system according to claim 1, wherein first inner and outer grommet are provided with a grommet pair length and the first positioning surface is provided with a length that measures at least 3 times greater than the grommet pair length.

7. A link assembly for a vehicle suspension system comprising:
a) a shaft provided with an axis and a positioning surface that includes threads;
b) an arm coupler including a pair of grommet contacting members and an interfacing assembly, wherein:
i) the interfacing assembly includes an interfacing member that receives the positioning surface on the shaft and inner and outer grommets that are provided with inner surfaces that receive the interfacing member;
ii) the pair of grommet contacting members includes an inner grommet contacting member that receives the positioning surface on the shaft and contacts the inner grommet and an outer grommet contacting member that receives the positioning surface on the shaft and contacts the outer grommet; and
c) a positioning member that receives the positioning surface on the shaft and includes threads that couple with the threads on the shaft, wherein the positioning member contacts the inner grommet contacting member and adjustably positions the arm coupler along the axis of the shaft.

8. A link assembly for a vehicle suspension system according to claim 7, wherein:
a) the inner and outer grommets are provided with an axis and include a load receiving surface, an arm engaging surface configured to contact an arm of a vehicle suspension system, and an expanding surface configured to expand radially outward with respect to the axis as the inner and outer grommets are compressed, wherein:
i) the expanding surface is located between the load receiving surface and the arm engaging surface;
ii) the load receiving surface on the inner grommet is configured to contact the inner grommet contacting member and the load receiving surface on the outer grommet is configured to contact the outer grommet contacting member;
b) the inner grommet contacting member is provided with a controlling surface that contacts the expanding surface on the inner grommet and limits the radial expansion of the inner grommet; and
c) the outer grommet contacting member is provided with a controlling surface that contacts the expanding surface on the outer grommet and limits the radial expansion of the outer grommet.

9. A link assembly for a vehicle suspension system according to claim 7, wherein:
b) the inner grommet contacting member exerts an axial load on the inner grommet and contact between the inner grommet contacting member and the interfacing member limits an amount of the axial load exerted on the inner grommet; and
c) the outer grommet contacting member exerts an axial load on the outer grommet and contact between the outer grommet contacting member and the interfacing member limits an amount of the axial load exerted on the outer grommet.

10. A link assembly for a vehicle suspension system according to claim 7, wherein first inner and outer grommet are provided with a grommet pair length and the first positioning surface is provided with a length that measures from about 1.5 to about 6 times greater than the grommet pair length.

11. A link assembly for a vehicle suspension system according to claim 7, wherein first inner and outer grommet are provided with a grommet pair length and the first positioning surface is provided with a length that measures at least 3 times greater than the grommet pair length.

12. A link assembly for a vehicle suspension system, comprising:
a) a shaft provided with an axis and first and second positioning surfaces that include threads;
b) a first arm coupler including a first interfacing assembly and a first pair of grommet contacting members, wherein:
i) the first interfacing assembly includes a first interfacing member that receives the first positioning surface of the shaft and first inner and outer grommets that include inner surfaces that receive the first interfacing member;
ii) the first pair of grommet contacting members including a first inner grommet contacting member and a first outer grommet contacting member that receive the first positioning surface of the shaft, wherein the first inner grommet contacting member is configured to contact the first inner grommet and the first outer grommet contacting member is configured to contact the first outer grommet;
c) a second arm coupler including a second interfacing assembly and a second pair of grommet contacting members, wherein:
i) the second interfacing assembly includes a second interfacing member that receives the second positioning surface of the shaft and second inner and outer grommets that include inner surfaces that receive the second interfacing member; and
ii) the second pair of grommet contacting members including a second inner grommet contacting member and a second outer grommet contacting member that receive the second positioning surface of the shaft, wherein the second inner grommet contacting member is configured to contact the second inner grommet and the second outer grommet contacting member is configured to contact the second outer grommet.

13. A link assembly for a vehicle suspension system according to claim 12, wherein first inner and outer grommet are provided with a grommet pair length and the first positioning surface is provided with a length that measures from about 1.5 to about 6 times greater than the grommet pair length.

14. A link assembly for a vehicle suspension system according to claim 12, wherein first inner and outer grommet are provided with a grommet pair length and the first positioning surface is provided with a length that measures at least 3 times greater than the grommet pair length.

15. A link assembly for a vehicle suspension system according to claim 12, wherein:
a) the first positioning includes a first threaded surface that is provided with a length; and
b) the second positioning surface includes a second threaded surface that includes a length that measures smaller than the length of the first threaded surface.

16. A link assembly for a vehicle suspension system according to claim 12, further comprising a positioning member that receives the first positioning surface, wherein the positioning member contacts the first inner grommet contacting member and adjustably positions the first arm coupler along the axis of the shaft.

17. A link assembly for a vehicle suspension system according to claim 12, further comprising:
a) a first positioning member that receives the first positioning surface, wherein the first positioning member contacts the first inner grommet contacting member and adjustably positions the first arm coupler along the axis of the shaft; and
b) a second positioning member that receives the second positioning surface, wherein the second positioning member contacts the second inner grommet contacting member and adjustably positions the second arm coupler along the axis of the shaft.

18. A link assembly for a vehicle suspension system according to claim 12, further comprising:
a) a first positioning member that receives the first positioning surface and contacts the first inner grommet contacting member;
b) a second positioning member that receives the second positioning surface and contacts the second inner grommet contacting member;
c) a third positioning member that receives the first positioning surface, contacts the first outer grommet contacting member and cooperates with the first positioning member to adjustably position the first arm coupler along the axis of the shaft; and
d) a fourth positioning member that receives the second positioning surface, contacts the second outer grommet contacting member, and cooperates with the second positioning member to adjustably position the second arm coupler along the axis of the shaft.

19. A link assembly for a vehicle suspension system according to claim 12, wherein:
a) the first inner grommet contacting member exerts an axial load on the first inner grommet and contact between the first inner grommet contacting member and the first interfacing member limits an amount of the axial load exerted on the first inner grommet; and
b) the first outer grommet contacting member exerts an axial load on the first outer grommet and contact between the first outer grommet contacting member and the first interfacing member limits an amount of the axial load exerted on the first outer grommet.

20. A link assembly for a vehicle suspension system according to claim 12, wherein:
a) the first inner and outer grommets are provided with an axis and include a load receiving surface, an arm engaging surface, and an expanding surface, wherein the expanding surface is located between the load receiving surface and the arm engaging surface;
b) the load receiving surface on the first inner grommet is configured to contact the first inner grommet contacting member and the load receiving surface on the first outer grommet is configured to contact the first outer grommet contacting member;
c) the arm engaging surfaces on the first inner and outer grommets are configured to contact an arm of a vehicle suspension system;
d) the expanding surfaces on the first inner and outer grommets are configured to expand radially outward with respect to the axis as the first inner and outer grommets are compressed;
e) the first inner grommet contacting member includes a controlling surface that contacts the expanding surface on the first inner grommet and limits the radial expansion of the first inner grommet; and
f) the first outer grommet contacting member includes a controlling surface that contacts the expanding surface on the first outer grommet and limits the radial expansion of the first outer grommet.
